(19) United States
(12) Patent Application Publication
(10) Pub. No.: US 2010/0033073 A1
(43) Pub. Date: Feb. 11, 2010

(54) INTEGRATED LAMP AND LIGHT SOURCE SYSTEM HAVING SAME

(75) Inventor: Shih-Hsien Chang, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/326,247

(22) Filed: Dec. 2, 2008

(30) Foreign Application Priority Data
Aug. 8, 2008 (TW) 097130281

(51) Int. Cl. H01J 5/00

(52) U.S. Cl. 313/324

(57) ABSTRACT

An integrated lamp includes a transparent tube body, a passive component and a covering part. The passive component is disposed at an end of the transparent tube body, and electrically connected to the transparent tube body. The covering part is electrically connected to the passive component and has a receptacle. The end of the transparent tube body is sheathed by the covering part such that the passive component is accommodated within the receptacle.

### FIELD OF THE INVENTION

The present invention relates to a lamp, and more particularly to an integrated lamp by integrating a passive component therewith. The present invention also relates to a light source system having such an integrated lamp.

### BACKGROUND OF THE INVENTION

Lamps are widely used in lighting systems such as flat panel display devices and indoor lighting devices. For example, a flat panel display device such as a liquid crystal display (LCD) has multiple cold cathode fluorescent lamps (CCFLs) as light sources. These lamps are usually driven by a driving circuit such as an inverter and the stability of the lamps is also controlled by the inverter.

FIG. 1 is a schematic view of a conventional LCD device. As shown in FIG. 1, the conventional LCD device 1 principally comprises a main body 10, multiple lamps 11, multiple substrates 12 and an inverter 13. The substrates 12 are disposed within the main body 10 and at two opposite sides of the main body 10. The lamps 11 are cold cathode fluorescent lamps (CCFLs), which are arranged within the main body 10 in parallel. Both ends of each lamp 11 have respective contact terminals 111. The contact terminals 111 are electrically connected to trace patterns (not shown) or conductive wires (not shown) on the substrates 12. Via the contact terminals 111 and the trace patterns or conductive wires, the lamps 11 are electrically connected to the substrates 12. The inverter 13 is disposed outside of the main body 10. The inverter 13 is electrically connected to the trace patterns or conductive wires of the substrates 12 via jumper wires 14. Consequently, the inverter 13 is electrically connected to the lamps 11 for controlling and driving illumination of the lamps 11 and maintaining the lighting stability.

Recently, as the size of the LCD device is increased, the number and the size of the lamps are both increased. In a case that the currents passing through lamps are not identical, the brightness will not be uniform. Under this circumstance, the lamps will be quickly aged and thus the use life of the lamps will be shortened. For assuming uniform brightness of the LCD device and preventing quick ageing of the lamps, additional passive components 15 are soldered on both ends of the lamps 11. The passive components 15 are for example capacitors or inductors. Each passive component 15 is electrically interconnected between a contact terminal 111 of a corresponding lamp 11 and the trace patterns or conductive wires of the substrates 12. Due to the characteristics of the passive component 15, the currents passing through all of the lamps 11 are substantially equal.

Although the passive components 15 are effective to balance the currents passing through all of the lamps 11, there are still some drawbacks. For example, since the passive components 15 are successively welded on the substrates 12 to make electrical connection between the lamps 11 and the trace patterns or conductive wires of the substrates 12, the fabricating process of the LCD device 1 is very complicated and the throughput is usually insufficient.

Therefore, there is a need of providing an integrated lamp and a light source system having such an integrated lamp so as to obviate the drawbacks encountered from the prior art.

### SUMMARY OF THE INVENTION

An object of the present invention provides an integrated lamp and a power source system, in which the passive components are no longer welded on the substrates so as to simplify the fabricating process of the power source system and enhance the throughput.

In accordance with an aspect of the present invention, there is provided an integrated lamp. The integrated lamp includes a transparent tube body, a passive component and a covering part. The passive component is disposed at an end of the transparent tube body, and electrically connected to the transparent tube body. The covering part is electrically connected to the passive component and has a receptacle. The end of the transparent tube body is sheathed by the covering part such that the passive component is accommodated within the receptacle.

In accordance with another aspect of the present invention, there is provided a power source system. The power source system includes a main body, an integrated lamp and an inverter. The integrated lamp includes a transparent tube body, a passive component and a covering part. The passive component is disposed at an end of the transparent tube body, and electrically connected to the transparent tube body. The covering part is electrically connected to the passive component and has a receptacle. The end of the transparent tube body is sheathed by the covering part such that the passive component is accommodated within the receptacle. The inverter is electrically connected to the covering part of the integrated lamp for driving illumination of the integrated lamp.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view of a conventional LCD device;

FIG. 2 is a schematic view illustrating an integrated lamp according to a preferred embodiment of the present invention;

FIG. 3 schematically illustrates a variation example of the passive component shown in FIG. 2;

FIG. 4 schematically illustrates another variation example of the passive component shown in FIG. 2;

FIG. 5 schematically illustrates a further variation example of the passive component shown in FIG. 2;

FIG. 6 is a schematic view illustrating a power source system according to a first preferred embodiment of the present invention;

FIG. 7 is a schematic view illustrating a power source system according to a second preferred embodiment of the present invention;

FIG. 8 is a schematic view illustrating a power source system according to a third preferred embodiment of the present invention; and

FIG. 9 is a schematic view illustrating a power source system according to a fourth preferred embodiment of the present invention.

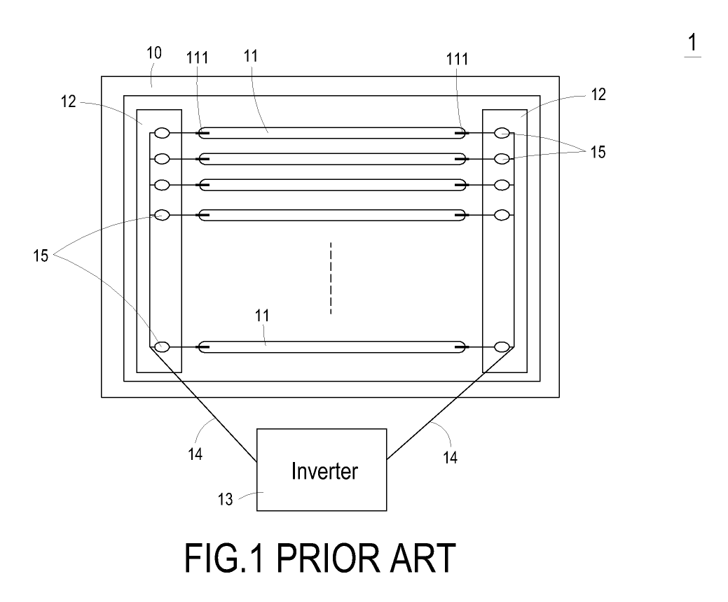

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

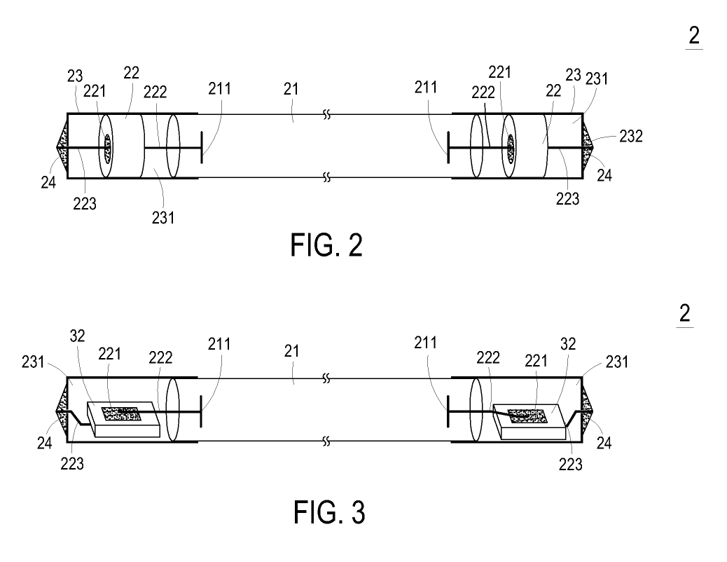

FIG. 2 is a schematic view illustrating an integrated lamp according to a preferred embodiment of the present invention. The integrated lamp can be applied to lighting systems such as flat panel display devices and indoor lighting devices. An example of the integrated lamp 2 includes but is not limited to a cold cathode fluorescent lamp (CCFL). The integrated lamp 2 includes a transparent tube body 21, multiple passive components 22 and multiple covering parts 23. Two conductive parts 211 are disposed within and at both ends of the transparent tube body 21.

The passive components 22 are disposed on bilateral sides of the transparent tube body 21. In this embodiment, the passive components 22 are disc-type ceramic capacitors. Each passive component 22 has multiple electrodes 221, a first conductive terminal 222 and a second conductive terminal 223. The first conductive terminal 222 and the second conductive terminal 223 are opposed to each other with respect to the disc-type ceramic capacitor 22 and connected to corresponding electrodes 221. In addition, the first conductive terminal 222 is electrically connected to a corresponding conductive part 211 of the transparent tube body 21 such that the disc-type ceramic capacitor 22 is electrically connected to the transparent tube body 21.

The covering parts 23 are made of conductive materials such as metallic materials. The covering parts 23 are sheathed around both ends of the transparent tube body 21. Each covering part 23 has a receptacle 231 and an opening 232. The opening 232 faces a corresponding second conductive terminal 223 of the disc-type ceramic capacitors 22. When the covering parts 23 are sheathed around both ends of the transparent tube body 21, the disc-type ceramic capacitors 22 are accommodated within the receptacles 231 of covering parts 23 and the second conductive terminals 223 pierce through corresponding openings 232. In some embodiments, the portions of the second conductive terminals 223 that pierce through the openings 232 are coated with a soldering material 24. Via the soldering material 24, the second conductive terminals 223 are electrically connected to the covering parts 23. In addition, the disc-type ceramic capacitors 22 are fixed in the receptacles 231 of the covering parts 23 via the soldering material 24.

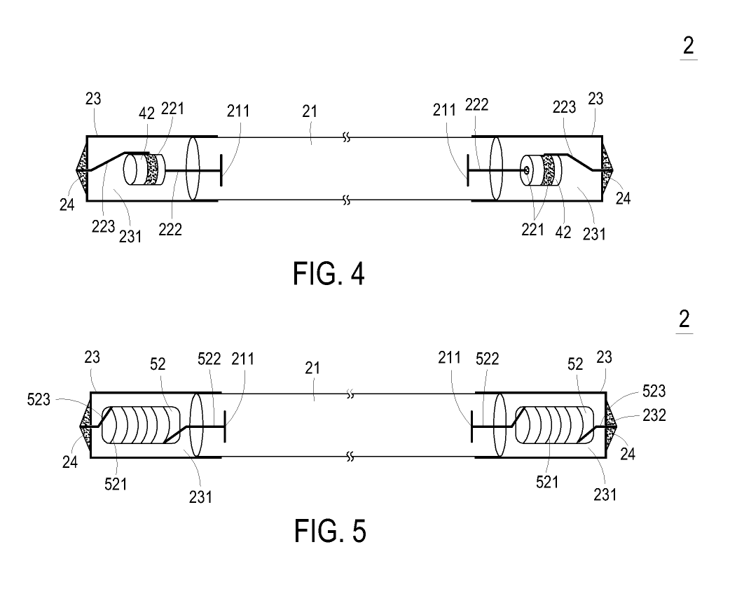

The passive component used in the integrated lamp of the present invention is not limited to the disc-type ceramic capacitor 22 as shown in FIG. 2. FIGS. 3 and 4 schematically illustrate two variations of the passive components. As shown in FIGS. 3 and 4, rectangular ceramic capacitors 32 and feed-through ceramic capacitors 42 are respectively used in replace of the disc-type ceramic capacitors 22. Similarly, each of the rectangular ceramic capacitor 32 and the feed-through ceramic capacitor 42 has multiple electrodes 221, a first conductive terminal 222 and a second conductive terminal 223. The relations between the electrodes 221, the first conductive terminal 222, the second conductive terminal 223, the transparent tube body 21 and the covering parts 23 are similar to those shown in FIG. 2, and are not redundantly described herein.

The passive component used in the integrated lamp of the present invention is not limited to the capacitor as described in FIGS. 2, 3 and 4. In this embodiment, the passive component is an inductor. As shown in FIG. 5, the passive component is a wire-wound inductor 52 comprising a winding coil 521, a first conductive terminal 522 and a second conductive terminal 523. The first conductive terminal 522 and the second conductive terminal 523 are connected to both ends of the winding coil 521. In addition, the first conductive terminal 522 is also connected to an adjacent conductive part 211 of the transparent tube body 21 such that the wire-wound inductor 52 is electrically connected to the transparent tube body 21. Likewise, the second conductive terminals 523 piercing through corresponding openings 232 of the covering parts 23. In some embodiments, the portions of the second conductive terminals 223 that pierce through the openings 232 are coated with soldering material 24. Via the soldering material 24, the second conductive terminals 223 are electrically connected to the covering parts 23. In addition, the wire-wound inductors 52 are fixed in the receptacles 231 of the covering parts 23 via the soldering material 24.

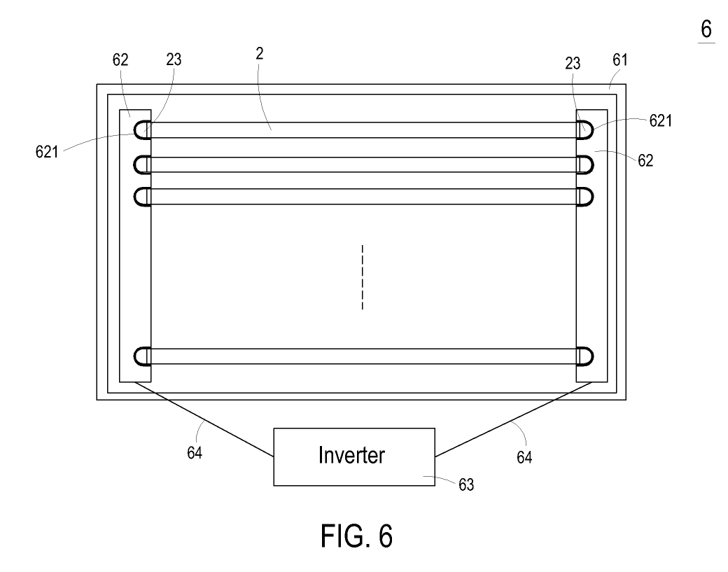

FIG. 6 is a schematic view illustrating a power source system according to a first preferred embodiment of the present invention. An example of the power source system includes but is not limited to a flat panel display device or an indoor lighting device. As shown in FIG. 6, the power source system 6 is a flat panel display device comprises a main body 61, multiple substrates 62, an inverter 63 and multiple jumper wires 64 and multiple integrated lamps 2. The integrated lamps 2 are selected from the integrated lamps 2 of FIGS. 2, 3, 4 or 5 or the combination thereof.

In this embodiment, the substrates 62 are made of conductive materials such as metallic materials. The substrates 62 are disposed within the main body 60 and at two opposite sides of the main body 60. Moreover, corresponding to the covering parts 23 of the integrated lamps 2, multiple engaging structures 621 are formed in/on the surface of the substrates 62. Likewise, the engaging structures 621 are made of conductive materials such as metallic materials. When the covering parts 23 are engaged with the engaging structures 621, the integrated lamps 2 are firmly fixed on the substrates 62 and within the main body 60 in parallel. In addition, when the covering parts 23 are engaged with the engaging structures 621, the second conductive terminals 223 of the passive components piercing through corresponding openings 232 of the covering parts 23 are also electrically connected to the corresponding engaging structures 621. Since the engaging structures 621 are electrically connected with the substrates 62, the integrated lamps 2 are electrically connected with the substrates 62 through the engaging structures 621.

In some embodiments, the substrates 62 are circuit boards. The circuit boards have trace patterns or conductive wires thereon to be electrically connected to the engaging structures 621. Via the engaging structures 621, the integrated lamps 2 are electrically connected with the circuit boards.

Please refer to FIG. 6 again. Examples of the jumper wires 64 are high-voltage conductive wires to be used as connecting media between the substrates 62 and the inverter 63. In this embodiment, the majority of each jumper wire 64 is arranged outside of the main body 61 but only a small portion of the jumper wire 64 is buried inside the main body 61. The inverter 63 is arranged outside of the main body 61. Via the jumper wires 64, the inverter 63 is electrically connected with the substrates 62 and the integrated lamps 2 for controlling and driving illumination of the integrated lamps 2.

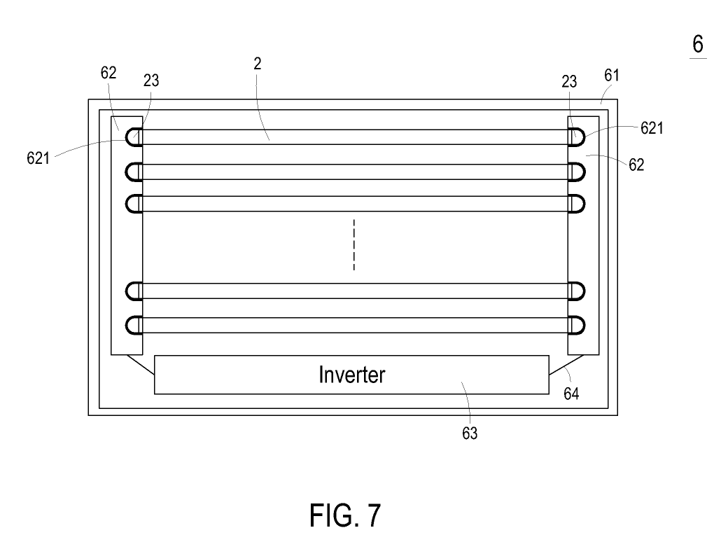

FIG. 7 schematically illustrates a power source system according to a second preferred embodiment of the present invention. The main body 61, the substrates 62 and the integrated lamps 2 included in this embodiment are similar to those shown in FIG. 6, and are not redundantly described herein. In addition, the inverter 63 is disposed inside the main body 61 and the jumper wires 64 are also buried inside the main body 61.

Since the integrated lamps 2 have respective passive components, the currents passing through the integrated lamps 2 of the LCD device 6 are identical through collective operations of the passive components. In addition, since the integrated lamps 2 are engaged with the engaging structures 621 of the substrates 62, the process of assembling the integrated lamps 2 is simplified in comparison with the conventional technology of welding passive components on the substrates. In other words, the fabricating process of the LCD device 6 is simplified and thus the throughput is enhanced.

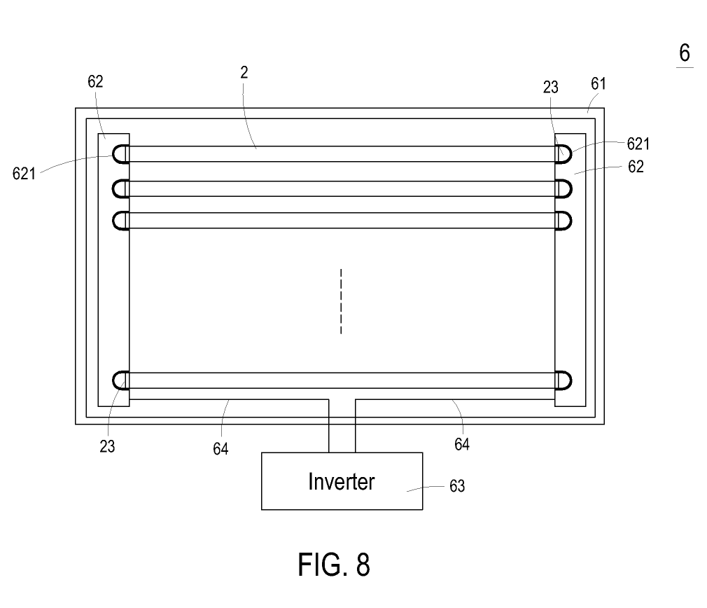

FIG. 8 schematically illustrates a power source system according to a third preferred embodiment of the present invention. The main body 61, the substrates 62 and the integrated lamps 2 included in this embodiment are similar to those shown in FIG. 6, and are not redundantly described herein. In addition, the majorities of the jumper wires 64 are buried inside the main body 61 but small portions of the jumper wires 64 are disposed outside of the main body 61 to be connected with the inverter 63. Under this circumstance, the high-voltage interference caused by the jumper wires 64 outside the main body 61 is considerably reduced.

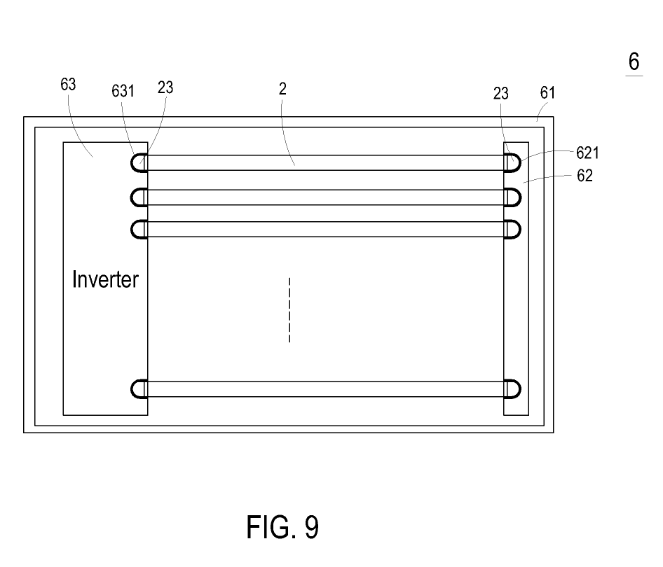

FIG. 9 schematically illustrates a power source system according to a fourth preferred embodiment of the present invention. The main body 61 and the integrated lamps 2 included in this embodiment are similar to those shown in FIG. 6, and are not redundantly described herein. In this embodiment, a substrate 62 of the LCD device 6 shown in FIG. 6 is replaced by the inverter 63. That is, the LCD device 6 of this embodiment has only one substrate 62 and the inverter 63 is disposed within the main body 61. Moreover, the inverter 63 has multiple engaging structures 631, which are opposite to the engaging structures 621 of the substrate 62 with respect to the integrated lamps 2. The configurations of the engaging structures 631 of the inverter 63 are substantially the same as those of the engaging structures 621 of the substrate 62. When the covering parts 23 are engaged with the engaging structures 631 of the inverter 63 and the engaging structures 621 of the substrate 62, the integrated lamps 2 are firmly fixed within the main body 60 in parallel.

In this embodiment, the engaging structures 631 of the inverter 63 are made of conductive materials such as metallic materials. When the covering parts 23 are engaged with the engaging structures 631 of the inverter 63, the inverter 63 is electrically connected with the integrated lamps 2 through the engaging structures 631, thereby controlling and driving illumination of the integrated lamps 2. In addition, since the LCD device 6 of this embodiment has only one substrate 62 and the inverter 63 is disposed within the main body 61, no jumper wire is required to electrically connect the inverter 63 with the integrated lamps 2 and the fabricating cost is reduced.

From the above description, the integrated lamp of the present invention is fabricated by integrating at least a passive component within a transparent tube body and electrically connecting to a covering part. Due to the characteristics of the passive component, the currents passing through all of the integrated lamps of the power source system are substantially equal. Moreover, when the covering parts of the integrated lamps are engaged with the engaging structures of the substrate or the inverter, the integrated lamps including the passive components can be easily mounted on the flat panel display device. Since the passive components are no longer welded on the substrates, the process of fabricating the flat panel display device is simplified and the throughput is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An integrated lamp comprising:
a transparent tube body;
a passive component disposed at an end of said transparent tube body, and electrically connected to said transparent tube body; and
a covering part electrically connected to said passive component and having a receptacle, wherein said end of said transparent tube body is sheathed by said covering part such that said passive component is accommodated within said receptacle.

2. The integrated lamp according to claim 1 wherein said integrated lamp is a cold cathode fluorescent lamp.

3. The integrated lamp according to claim 1 wherein said integrated lamp further includes a conductive part.

4. The integrated lamp according to claim 3 wherein said passive component comprises a first conductive terminal and a second conductive terminal, which are disposed on opposite sides of said passive component, wherein said first conductive terminal is electrically connected to said conductive part of said transparent tube body such that said passive component is electrically connected to said transparent tube body.

5. The integrated lamp according to claim 4 wherein said covering part further comprises an opening facing said second conductive terminal, and said second conductive terminal pierces through said opening when said passive component is accommodated within said receptacle.

6. The integrated lamp according to claim 5 wherein said covering part is made of a metallic material.

7. The integrated lamp according to claim 6 wherein the portion of said second conductive terminal that pierces through said opening is coated with a soldering material, thereby facilitating electrical connection between said second conductive terminal and said covering part and fixing said second conductive terminal on said covering part.

8. The integrated lamp according to claim 1 wherein said passive component is selected from a disc-type ceramic capacitor, a rectangular ceramic capacitor, a feed-through ceramic capacitor or a wire-wound inductor.

9. A power source system comprising:
a main body;
an integrated lamp comprising:
a transparent tube body;
a passive component disposed at an end of said transparent tube body, and electrically connected to said transparent tube body;
a covering part electrically connected to said passive component and having a receptacle, wherein said end of said transparent tube body is sheathed by said covering part such that said passive component is accommodated within said receptacle; and
an inverter electrically connected to said covering part of said integrated lamp for driving illumination of said integrated lamp.

10. The power source system according to claim 9 wherein said power source system is a flat panel display device.

11. The power source system according to claim 9 wherein said power source system further comprises a substrate at one side and within said main body of said power source system, and said substrate has an engaging structure in a surface thereof to be engaged with said covering part of said integrated lamp so as to fix said integrated lamp within said main body.

12. The power source system according to claim 11 wherein said engaging structure, said substrate and said covering part of said integrated lamp are made of metallic material, and said covering part is electrically connected to said substrate through said engaging structure when said engaging structure is engaged with said covering part.

13. The power source system according to claim 12 wherein said power source system further comprises a jumper wire, which is electrically connected to said substrate and said inverter such that said inverter is electrically connected to said integrated lamp through said jumper wire.

14. The power source system according to claim 9 wherein said inverter is disposed within said main body, and said inverter comprises an engaging structure to be engaged with said covering part of said integrated lamp so as to fix said integrated lamp within said main body.

15. The power source system according to claim 14 wherein said engaging structure of said inverter and said covering part of said integrated lamp are made of metallic material, and said covering part is electrically connected to said inverter through said engaging structure when said engaging structure is engaged with said covering part.
